(19) United States
(12) Patent Application Publication
(10) Pub. No.: US 2007/0227609 A1
(43) Pub. Date: Oct. 4, 2007

(54) Rubber composition and fuel system rubber hose

(75) Inventors: Hidekazu Kurimoto, Aichi-ken (JP); Hidenori Hayashi, Aichi-ken (JP); Yohei Terada, Aichi-ken (JP)

Correspondence Address: POSZ LAW GROUP, PLC, 12040 SOUTH LAKES DRIVE, SUITE 101, RESTON, VA, 20191, US

(73) Assignee: TOYODA GOSEI CO., LTD., Aichi-ken (JP)

(21) Appl. No.: 11/727,594

(22) Filed: Mar. 27, 2007

(30) Foreign Application Priority Data
Mar. 30, 2006 (JP) 2006-094134

(51) Int. Cl. F16L 11/00

(52) U.S. Cl. 138/137; 428/36.91

(57) ABSTRACT

A sulfur-vulcanized rubber composition comprising magnesium oxide incorporated in a blend of a hydrogenated NBR and PVC in an amount of from 2 to 5 parts by weight based on 100 parts by weight of the blend. A fuel system rubber hose comprising this rubber composition as an inner tube rubber.

### BACKGROUND OF THE INVENTION

1. Field of the Invention

The present invention relates to a hydrogenated NBR-PVC blend rubber composition comprising magnesium oxide incorporated therein and a fuel system rubber hose comprising the rubber composition as an inner tube rubber.

2. Related Art

The inner tube rubber of a fuel system rubber hose has been required to meet basic requirements for low fuel permeability and high fuel oil resistance (including sour fuel oil resistance). In recent years, the inner tube rubber has been required to have biofuel resistance (colza oil resistance). Further, the inner tube has been required to have ozone resistance at the end thereof as well from the standpoint of apprehension of fuel leakage.

Further, a fuel system rubber hose is used also in diesel engine. However, the spray nozzle in the common rail of diesel engine can undergo clogging. It has been made obvious that the product of reaction of aliphatic acid extracted from the inner tube rubber with zinc is a causative agent.

Therefore, it has also been required to inhibit the production of reaction products from the hose. Fluororubber can meet these requirements but is expensive and thus is not practical.

The use of a blend of hydrogenated NBR (acrylonitrile-butadiene rubber) and PVC (polyvinyl chloride) as an inner tube rubber in fuel system rubber hose is disclosed in JP-A-10-279733 and JP-A-2002-103412. This blend can meet requirements for low fuel permeability, fuel oil resistance, biofuel resistance (colza resistance) and ozone resistance, which are properties characteristic to rubber, but cannot suppress the generation of reaction products.

On the other hand, JP-A-2003-287162 discloses the application of peroxide-vulcanized hydrogenated NBR composition having magnesium oxide incorporated therein to heat resistant fuel system hose. However, this product has magnesium oxide incorporated therein as an acid receiving agent and thus cannot suppress the generation of reaction products.

### SUMMARY OF THE INVENTION

An aim of the invention is to provide a rubber composition having fuel oil resistance (sour fuel oil resistance), biofuel resistance (colza oil resistance) and ozone resistance. Another aim of the invention is to provide a fuel system rubber hose which comprises this rubber composition as an inner tube of fuel system hose but generates no reaction products.

The invention employs the following constitutions to solve the aforementioned problems.

A sulfur-vulcanized rubber composition comprising:

100 parts by weight of a blend of a hydrogenated NBR and PVC; and

an amount of from 2 to 5 parts by weight of magnesium oxide incorporated in the blend.

In the invention, a blending ratio of the hydrogenated NBR to PVC may be in a range from 95 parts to 5 parts to 50 parts to 50 parts.

The fuel system rubber hose as defined above, further comprising an outer rubber in which the inner tube rubber is provided, wherein the outer rubber is a hydrin rubber, CSM (chlorosulfonated polyethylene), EPDM, chloroprene rubber or blend of NBR and EPDM.

Embodiments of the various elements in the invention will be exemplified below.

### 1. Hydrogenated NBR

The hydrogenated NBR has an acrylonitrile content of from 36% to 55%, preferably from 43% to 50% and has a percent hydrogenation of 70% or more, preferably 90% or more. When the percent hydrogenation falls below 70%, the aims of the invention cannot be accomplished.

### 2. PVC

The polymerization degree of PVC is from 200 to 3,000, preferably from 800 to 1,500.

### 3. Blending Ratio of Hydrogenated NBR and PVC

The blending ratio of hydrogenated NBR is from 50 to 95 parts by weight, preferably from 60 to 80 parts by weight and the blending ratio of PVC is from 5 to 50 parts by weight, preferably from 20 to 40 parts by weight. When the blending ratio of PVC falls below 5 parts by weight, the resulting blend cannot exhibit satisfactory ozone resistance. On the other hand, when the blending ratio of PVC exceeds 50 parts by weight, the resulting blend exhibits a raised hardness and thus loses flexibility when used as a hose.

### 4. Skin Rubber (Outer Rubber)

An inexpensive rubber excellent in ordinary requirements such as weathering resistance, ozone resistance, fuel oil resistance and oil resistance is preferably used. Examples of such a rubber include hydrin rubber, CSM, EPDM, and chloroprene rubber.

### 5. Added Amount of Magnesium Oxide

Magnesium oxide is incorporated in an amount of from 2 to 5 parts by weight, preferably from 3 to 4 parts by weight based on 100 parts by weight of the blend of hydrogenated NBR and PVC. When the amount of magnesium oxide to be incorporated falls below 2 parts by weight, the reaction products separate out. When the amount of magnesium oxide to be incorporated exceeds 5 parts by weight, the resulting blend exhibits deteriorated permanent compression set.

### 6. Configuration of Fuel Rubber Hose

The thickness of the inner tube rubber is from 0.1 mm to 2 mm and the thickness of the skin rubber is from 3 mm to 5 mm. A polyester fiber, nylon fiber or the like is provided as a reinforcing layer interposed between the inner tube rubber and the skin rubber as necessary. A middle rubber layer is provided as necessary. Examples of the middle rubber include hydrin rubber, NBR, and blend of NBR and EPDM.

Since the rubber composition of the invention has fuel oil resistance (sour fuel oil resistance), biofuel resistance (colza oil resistance) and ozone resistance, the fuel system hose comprising this rubber composition as an inner tube rubber can meet the aforementioned requirements and generates no reaction products.

### DETAILED DESCRIPTION OF THE PREFERRED EMBODIMENT

A preferred embodiment of the invention is a sulfur-vulcanized rubber composition comprising magnesium oxide incorporated in a blend of a hydrogenated NBR and PVC in an amount of from 2 to 5 parts by weight based on 100 parts by weight of the blend. Another preferred embodiment of the invention is a fuel system rubber hose comprising this rubber as an inner tube rubber and hydrin rubber, CSM, EPDM, chloroprene rubber or a blend of NBR and EPDM as a skin rubber.

### EXAMPLE

Various rubber compounds having the formulation set forth in Table 1 were each press-vulcanized at 170° C. for 15 minutes to prepare test pieces which were then subjected to test. For the test on product properties, hoses comprising various rubber compounds having the formulation set forth in Table 1 as an inner tube rubber and hydrin as a skin rubber were prepared.

In Table 1, the compounding agents 1 to 5 are as follow.

1. H-NBR/PVC (=70/30): PBZ123 (produced ZEON Corporation); AN44; Mooney viscosity: 81 (MS1+4: 100° C.); percent hydrogenation: 90%
2. H-NBR/PVC: (=70/30): AN44; Mooney viscosity: 90 (ML1+4; 100° C.)
3. NBR: DN103 (produced by ZEON Corporation); AN41.5; Mooney viscosity: 50 (ML1+4; 100° C.)
4. H-NBR: Zetpol 1020 (produced by ZEON Corporation); AN44; Mooney viscosity: 78 (ML1+4; 100° C.); percent hydrogenation 90%

### 5. Fluororubber (Produced by DAIKIN INDUSTRIES, ltd.)

The properties to be examined were sour fuel resistance, colza oil resistance, ozone resistance and whether or not reaction products are present (precipitation test). Various testing methods will be described below.

### [Sour Fuel Oil Resistance]

The test piece was dipped in Fuel D (copper ion: 0.1 ppm; peroxide value: 200 mg/kg) at 60° C. for 2 days (This procedure was repeated twice). The test piece thus treated was then evaluated for various physical properties.

### [Colza Oil Resistance]

A methylesterified colza oil was added to gas oil in an amount of 10% (The mixture is referred to as “10% biofuel”). The test piece was dipped in the 10% biofuel at 100° C. for 250 hours, and then evaluated for various physical properties.

### [Ozone Resistance]

### Test Piece:

The test piece was dipped in and extracted with Fuel D at 140° C. for 70 hours. Thereafter, the test piece was withdrawn from Fuel D, dried at room temperature (23° C.) for 24 hours, and then finally heated to 100° C. for 48 hours. The test piece was stretched by a factor of 20%, and then evaluated for ozone resistance under the conditions of 50 pphm, 40° C. and 168 hours. The occurrence of cracking was visually judged.

### Product:

The hose with clamp having Fuel D enclosed therein was allowed to stand at 40° C. for 48 hours. Thereafter, Fuel D was removed from the hose. The hose was then dried at room temperature for 24 hours.

The hose was then evaluated for ozone resistance under the conditions of 50 pphm, 40° C. and 168 hours. The occurrence of cracking was visually judged.

### [Reaction Product Precipitation Test]

18 g of a test piece having a size of 10 mm×10 mm×2 mm as dipped in 75 ml of 10% biofuel which was then retained in a 80° C. constant temperature tank for 72 hours. The biofuel from which the test piece had been removed was put in a measuring tube in which the reaction products were then separated by a centrifugal separator (1,000 rpm×30 minutes). The volume percentage of the reaction products were measured using the graduations on the measuring tube.

The results of physical properties of the materials and properties of the products are set forth in Table 1.

The blend of hydrogenated NBR and PVC having magnesium oxide incorporated therein of Example 1 exhibits a smaller amount of extract (precipitate) with biofuel as compared with the blend of hydrogenated NBR and PVC without magnesium oxide of Comparative Example 1. Further, Example 1 has better ozone resistance property as compared with Comparative Examples 2 and 3. On the other hand, the fluororubber of Reference Example exhibits satisfactory properties but is expensive.

TABLE 1

| | | | | Comparative | Comparative | Comparative | Reference |
|---|---|---|---|---|---|---|---|
| | | | Example 1 | Example 1 | Example 2 | Example 3 | Example |
| Formulation | Compounding agent | | 1 | 2 | 3 | 4 | 5 |
| | Polymer | | 100 | 100 | 100 | 100 | 100 |
| | Carbon black | | 50 | 50 | 85 | 60 | 15 |
| | Plasticizer | | 25 | 25 | 25 | 20 | |
| | Stearic acid | | 1.0 | 1.0 | 1.0 | 1.0 | |
| | Age inhibitor | | 3.0 | 3.0 | 3.0 | 3.0 | |
| | Zinc oxide | | 5.0 | 5.0 | 5.0 | 5.0 | |
| | Vulcanization accelerator | | 3.5 | 3.5 | 2.2 | 3.5 | |
| | Magnesium oxide #150 (Kyowa Chemical | | 3.0 | | | | 3.0 |
| | Industry Co., Ltd.) | | | | | | |
| | Calcium hydroxide | | | | | | 6.0 |
| | Calcium oxide | | | | | | 3.0 |
| | Powdered sulfur | | 0.5 | 0.5 | 0.5 | 0.5 | |
| | Total (parts) | | 191 | 187 | 222 | 193 | 127 |
| Material | Ordinary state | Hardness (Duro-A) | 65 | 68 | 68 | 70 | 76 |
| properties | physical properties | TB(MPa) | 25.8 | 21.5 | 12.7 | 21.0 | 10.1 |
| | | EB(%) | 530 | 630 | 660 | 620 | 330 |
| | Sour fuel resistance | ΔHS(point) | −10 | −6 | −5 | −11 | −15 |
| | | ΔTB(%) | −19 | −59 | −62 | −21 | −24 |
| | | ΔEB(%) | −17 | −62 | −70 | −16 | 3 |
| | Colza oil resistance | ΔHS(point) | +6 | +13 | +2 | +8 | −2 |
| | | ΔTB(%) | −13 | −23 | −25 | −4 | −10 |
| | | ΔEB(%) | −16 | −37 | −60 | −12 | −3 |
| | Ozone resistance (after | Visually judged | Not cracked | Not | Cracked | Cracked | Not cracked |
| | extracted with fuel) | | | cracked | | | |
| | Precipitation test | Amount precipitated | 0.07 or less | 0.55 | 0.79 | 0.53 | 0.07 or less |
| | | (vol-%) | | | | | |
| Product | Ozone resistance (after | Visually judged | Not cracked | Not cracked | Cracked | Cracked | Not cracked |
| properties | extracted with fuel) | | | | | | |

What is claimed is:

1. A sulfur-vulcanized rubber composition comprising:
100 parts by weight of a blend of a hydrogenated NBR and PVC; and
an amount of from 2 to 5 parts by weight of magnesium oxide incorporated in the blend.

2. A sulfur-vulcanized rubber composition defined in claim 1, wherein a blending ratio of the hydrogenated NBR to PVC is in a range from 95 parts to 5 parts to 50 parts to 50 parts.

3. A fuel system rubber hose comprising the rubber composition defined in claim 1 as an inner tube rubber.

4. The fuel system rubber hose as defined in claim 3, further comprising an outer rubber in which the inner tube rubber is provided, wherein the outer rubber is a hydrin rubber, CSM, EPDM, chloroprene rubber or blend of NBR and EPDM.

5. A fuel system rubber hose comprising the rubber composition defined in claim 2 as an inner tube rubber.

6. The fuel system rubber hose as defined in claim 5, further comprising an outer rubber in which the inner tube rubber is provided, wherein the outer rubber is a hydrin rubber, CSM, EPDM, chloroprene rubber or blend of NBR and EPDM.
